(19) United States
(12) Patent Application Publication
(10) Pub. No.: US 2008/0286028 A1
(43) Pub. Date: Nov. 20, 2008

(54) SOLID DEODORANT CONTAINER AND MECHANISM

(76) Inventor: Carl Lombardi, Lloyd Harbor, NY (US)

Correspondence Address: Bradley N. Ruben, PC, Suite 5A, 463 First St., Hoboken, NJ, 07030-1859, US

(21) Appl. No.: 12/185,564

(22) Filed: Aug. 4, 2008

Related U.S. Application Data
(60) Provisional application No. 61/061,395, filed on Jun. 13, 2008.

(51) Int. Cl. B43K 21/08

(52) U.S. Cl. 401/72; 401/75

(57) ABSTRACT

A dispenser for a solid product that is rubbed off includes a threaded riser on a threaded spindle having a stop at its free end to prevent the riser from coming off, thereby allowing the purchaser to have access to the entire amount of product purchased.

### RELATED APPLICATIONS

This application claims priority from U.S. application Ser. No. 61/061395, filed 13 Jun. 2008, the disclosure of which is incorporated herein by reference.

### BACKGROUND OF THE INVENTION

This invention relates to a container and mechanism for storing and advancing a solid material for dispensing by abrasion or friction, such as a gel deodorant stick or a polishing rouge.

In the area of cosmetics, products such as underarm deodorant is often sold as a solid material housed in a containing having a top opening exposing the solid material for application by rubbing the material against the skin. Such devices can include a central spindle having threads that directly engage the solid or a riser on which the solid is supported. Rotation of the spindle acts to advance (or retract, depending on the direction of rotation) the solid or the riser. Alternatively, the product can be pushed up from the bottom of the container. One problem with such devices and methods is that the solid product and/or the riser is apt to fall out of the container when there is little product remaining, yet the consumer desires to use all of the product packaged and not to have to discard any portion of the product.

### SUMMARY OF THE INVENTION

This invention provides a device having a housing for a solid product dispensed by rubbing, a central threaded spindle, a riser having a threaded bore that is translated along the spindle, the threads on the spindle and in the bore being external threads, and the free end of the spindle having a nub or cap that fits within the bore and has a diameter greater than the major diameter of the threads in the bore. The device can be made in virtually any shape, including round (circular, oval) and rectilinear (square, triangular) and can house a product having the same or different round or rectilinear shape.

### BRIEF DESCRIPTION OF THE DRAWINGS

FIG. 1A is a side view of one embodiment of the inventive device.

FIG. 1 B is a top view of the device shown in FIG. 1A without the cover.

FIG. 2 is a cross section taken along line 2-2 in FIG. 1A.

FIG. 3 is a cross section taken along line 3-3 in FIG. 1B with the riser near the top.

FIG. 4 is a close up view of the section 4 in FIG. 3.

FIG. 5A is a side view of another embodiment of the inventive device.

FIG. 5B is a top view of the device shown in FIG. 5A with the cover removed.

FIG. 6 is a cross section taken along line 6-6 in FIG. 5A.

FIG. 7 is a side view of the device shown in FIG. 5A without the cover and with the riser near the top.

FIG. 8 is a cross section taken along line 8-8 of FIG. 7.

### DETAILED DESCRIPTION OF SPECIFIC EMBODIMENTS

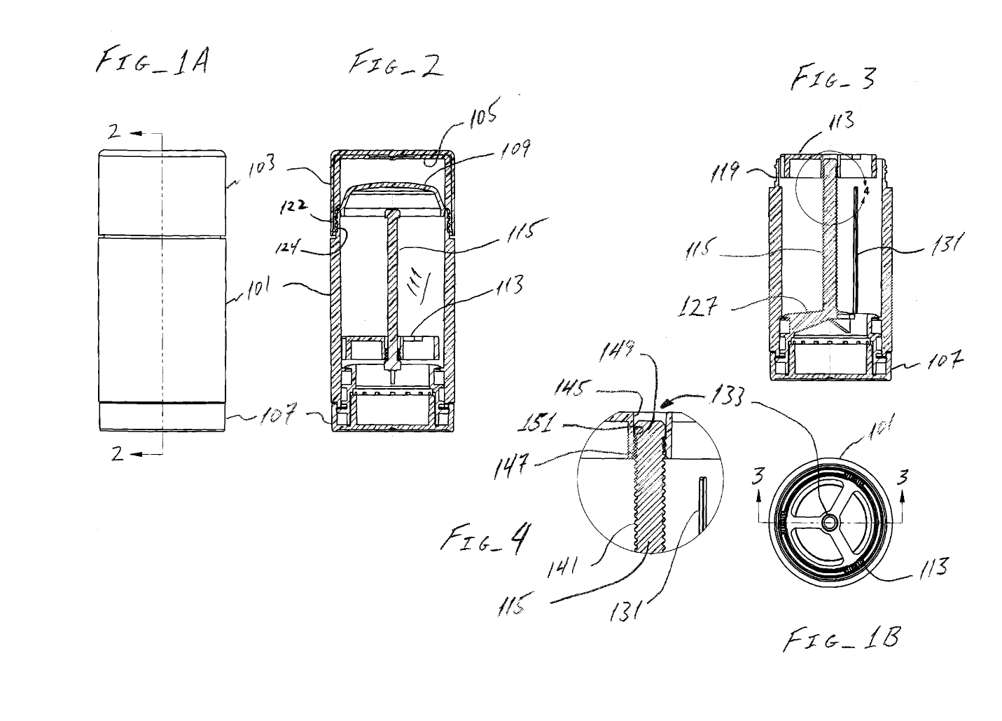

As shown in FIG. 1, a side view of a circularly shaped container for housing a product in the shape of a right rectangular solid, from the outside the is seen to have a housing 101, a outer cover 103, and a base 107. In the cross-section taken along line 2-2 in FIG. 1, the outer cover is seen to have an inner cover 105 (together comprising the “cover” as used herein) which are adhered or welded together. Unless otherwise stated, all of the parts of this device can be made from molded plastic, such as ABS, polypropyene, polystyrene, and other materials well-known in the industry. The bottom portion of the inside of the inner cover preferable contains threads 122 that engage corresponding threads 124 on the outer portion of a top flange 119 of the housing defining the opening to the cavity to enable the cover to be screwed on to the housing, although a snug or snap-fit is similarly suitable (as described below). When purchased, the product is protected by a shield 109 held in place between the inner cover and the top of the flange formed from the housing; when the cover is removed by the consumer the shield can then be removed. A portion of the inner wall of the housing defines a cavity 111 normally filled with the product and in which a riser 113 and spindle 115 are disposed. The top view of the device without cover shown in FIG. 1B depicts a bore 133 central to the riser that engages the spindle.

With reference to FIG. 3, a cross section taken along line 3-3 in FIG. 1B, a leg 127 connects the spindle to the base. The base is adapted to rotate while maintaining attachment to the housing. Rotation of the base thus rotates the spindle. The shaft of the spindle is provided with threads, as is the inside of the bore of the riser. Rotation of the base causes the spindle to rotate, in turn causing the rises to traverse the length spindle. As shown in FIG. 4, a detail of close-up 4 in FIG. 3, the spindle has external threads 141. The bore has an inner surface 145 from which external threads 147 extend towards the center of the bore. The free end of the spindle 149, the end opposite from the end attached to the base, is provided with a nub 151 dimensioned to fit within the bore defined by the inner surface, and to lack threads, thereby obstructing movement of the riser. The nub is larger than the minor diameter of the spindle thread, and preferably is approximately the major diameter of the spindle thread. Thus, as the riser advances along the spindle, the external threads in the bore are prevented from advancing by the nub. In essence, if the nub cannot fit through the bore, the riser will not come off the spindle.

A rib 131 is disposed, preferably parallel with the spindle, on inner wall of the housing defining the cavity. The solid product sits on the riser, essentially filling the cavity, and has a groove that cooperates with the rib (or a groove is formed by the rib as the product is forced into the cavity). As the base is turned, rotating the spindle, the rib functions as a baffle to prevent rotation of the solid product. The frictional force between the product and the riser keeps the two as an integral unit, while friction between the rib and the product prevents the product from rotating when the spindle rotates, and so rotation of the spindle is then transferred to axial displacement of the base/product along the spindle. As the riser reaches the free end of the spindle, the nub prevents the riser from coming off the spindle. As shown in FIG. 3, when fully axially displaced, the riser can extend past the free end of the flange defined by the housing so that ultimate portion of the product is made available to the purchaser.

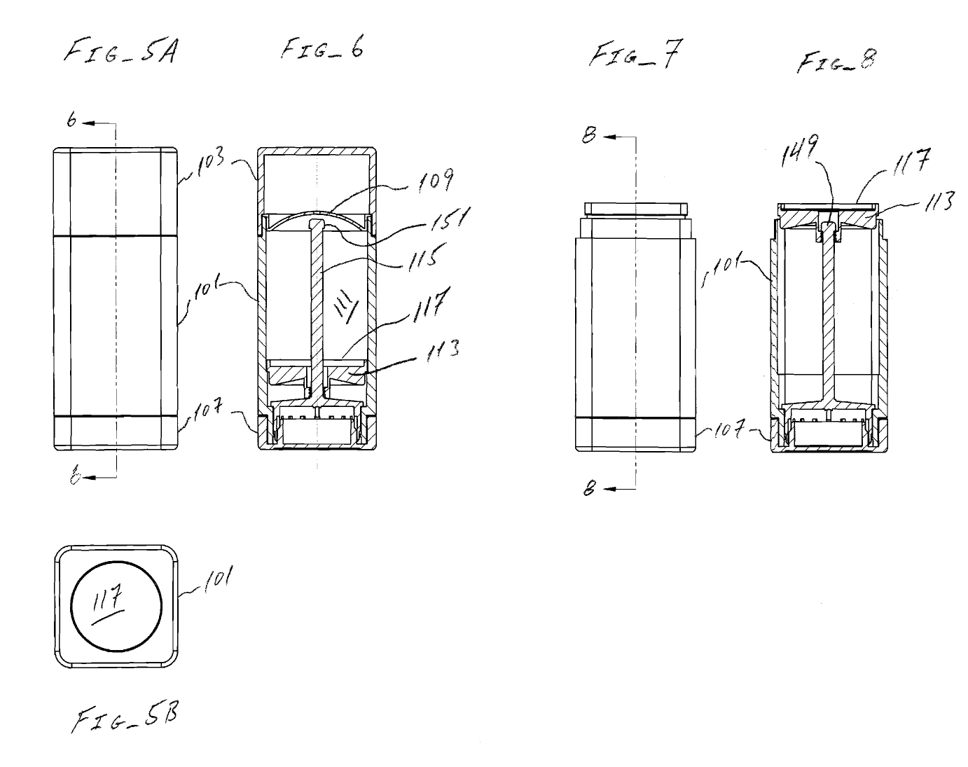

The outer appearance of the container, and/or the perimeter of the product, can be made in any polygonal, arcuate, or combined shape, such as circular, oval, “D”-shaped, triangular, and the like. For example, FIG. 1B depicts a circular perimeter whereas FIG. 5B depicts an essentially square perimeter (a square with chamferred or rounded edges). FIGS. 5A and 5B depict, respectively, a side view as in FIG. 1A, and a top view with the cover removed of a device with a rectilinear outer perimeter housing a cylindrically-shaped product, where FIG. 6 is a cross-section taken along line 6-6 in FIG. 5. As seen in FIG. 6, the cover can be a single piece that close fits with the flange. FIGS. 7 and 8 depict side and cross-sectional views with the cover removed of the device when the riser is displaced it greatest extent towards the free end of the spindle.

The foregoing description is meant to be illustrative and not limiting. Various changes, modifications, and additions may become apparent to the skilled artisan upon a perusal of this specification, and such are meant to be within the scope and spirit of the invention as defined by the claims.

What is claimed is:

1. A dispensing device comprising:
a housing for a solid product dispensed by rubbing, the housing having an inner wall defining a cavity in which the product resides, and a top flange defining an opening to the cavity;
a riser having a bore with external threads;
a spindle having external threads disposed within the cavity, the spindle threads cooperating with the bore threads, and a nub at a free end of the spindle adapted to stop axial displacement of the riser along the spindle;
a base accessible to a user of the device, rotationally attached to the housing, and attached to the spindle effective to rotate the spindle upon rotation of the base; and
a rib disposed along on the inner wall effective to prevent rotation of a solid product housed in the cavity upon rotation of the spindle.

2. The device of claim 1, wherein the cavity has a cross section that is round.

3. The device of claim 2, wherein the cavity is round or oval.

4. The device of claim 1, wherein the cavity has a cross section that is rectilinear.

5. The device of claim 4, wherein the cavity has a cross section that is square, rectangular, or triangular.

6. The device of claim 1, wherein the housing has a perimeter that is round.

7. The device of claim 6, wherein the perimeter is round or oval.

8. The device of claim 1, wherein the housing has a perimeter that is rectilinear.

9. The device of claim 8, wherein the housing has a perimeter that is square, rectangular, or triangular.

10. A dispenser for a solid product worn away during application there, comprising:
a housing having an inner wall defining a cavity in which the solid product resides, and a top flange defining an opening to the cavity;
a riser having a bore with external threads defining the bottom of the cavity opposite the opening;
a spindle having external threads disposed within the cavity and extending through the solid product, the spindle threads cooperating with the bore threads, and a nub at a free end of the spindle adapted to stop axial displacement of the riser along the spindle;
a base accessible to a user of the dispenser, rotationally attached to the housing, and attached to the spindle effective to rotate the spindle upon rotation of the base; and
a rib disposed along on the inner wall effective to prevent rotation of the solid product housed in the cavity upon rotation of the spindle.

11. The dispenser of claim 10, wherein the cavity has a cross section that is round or oval.

12. The dispenser of claim 10, wherein the cavity has a cross section that is rectilinear.

13. The dispenser of claim 11, wherein the housing has a perimeter that is curved.

14. The dispenser of claim 12, wherein the housing has a perimeter that is square, rectangular, or triangular.

15. A method for housing and dispensing a solid material applied by rubbing, comprising:
a. providing a container having a cavity with an open end and containing the solid material and an inner wall having a rib, a riser defining the bottom of the cavity and having a bore with external threads, a base rotatably coupled to the housing, and a spindle connected at one end to the base and having external threads and being disposed through the solid material, and a nub at the other end of the spindle preventing passage of the riser;
b. rotating the base effective to cause the riser to traverse the spindle and thereby push the solid material towards and out the opening, whereby the rib prevents rotation of the solid material.
